(19) United States
(12) Patent Application Publication
(10) Pub. No.: US 2026/0031440 A1
(43) Pub. Date: Jan. 29, 2026

(54) Rolled Aluminium Product for a Battery Cell Housing

(71) Applicants: Martin Christoph Lentz, Bonn (DE); Timo Weihberger, Hamburg (DE); Harald Dackweiler, Ahrensburg (DE); Nadia Telioui, Sande i Vestfold (NO)

(72) Inventors: Martin Christoph Lentz, Bonn (DE); Timo Weihberger, Hamburg (DE); Harald Dackweiler, Ahrensburg (DE); Nadia Telioui, Sande i Vestfold (NO)

(73) Assignee: Speira GmbH, Grevenbroich (DE)

(21) Appl. No.: 19/343,624

(22) Filed: Sep. 29, 2025

Related U.S. Application Data
(63) Continuation of application No. PCT/EP2024/059095, filed on Apr. 3, 2024.

(30) Foreign Application Priority Data
Apr. 4, 2023 (EP) 23166597.7
Nov. 3, 2023 (EP) 23207709.9
Dec. 19, 2023 (EP) 23218175.0

(51) Int. Cl. H01M 50/119; C22C 21/00; C22F 1/04; H01M 50/103; H01M 50/105; H01M 50/107

(52) U.S. Cl. CPC H01M 50/119; C22C 21/00; C22F 1/04; H01M 50/103; H01M 50/105; H01M 50/107

(57) ABSTRACT

A rolled product is made of an aluminium alloy ensures the cost-effective use of secondary aluminium and ensures processing capability on existing production facilities and equipment for the manufacture of battery cell housings. This is achieved by the rolled product made of an aluminium alloy for the manufacture of a battery cell housing having an aluminium alloy with the following alloy components in % by weight:

$$0.1 \% \leq Si \leq 0.7 \% ,$$

$$0.2 \% \leq Fe \leq 0.8 \% ,$$

$$Cu \leq 0.6 \% ,$$

$$0.3 \% \leq Mn \leq 1.5 \% ,$$

$$0.025 \% < Mg < 0.6 \% , preferably 0.05 \% < Mg < 0.55 \% ,$$

$$Cr \leq 0.25 \% ,$$

$$Zn \leq 0.5 \% ,$$

$$Ti \leq 0.2 \% ,$$

the remainder Al and unavoidable impurities, individually a maximum of 0.05%, in total a maximum of 0.15%. The rolled product has a tensile strength Rₘ of at least 135 MPa to a maximum of 210 MPa and an elongation A₅₀ of more than 5%.

### CROSS-REFERENCE TO RELATED PATENT APPLICATIONS

This patent application is a continuation of International Application No. PCT/EP2024/059095, filed on Apr. 3, 2024, which claims the benefit of priority to European Patent Application No. 23166597.7, filed Apr. 4, 2023, European Patent Application No. 23207709.9, filed Nov. 3, 2023, and European Patent Application No. 23218175.0, filed Dec. 19, 2023, the entire teachings and disclosures of all applications are incorporated herein by reference thereto.

### FIELD OF THE INVENTION

The invention relates to a rolled product made of an aluminium alloy for manufacturing a battery cell housing, a method for manufacturing the rolled product made of an aluminium alloy, the use of the rolled product made of an aluminium alloy for manufacturing a battery cell housing and a battery cell housing.

### BACKGROUND OF THE INVENTION

A rolled product is defined as rolled strips or sheets. Battery cell housings are manufactured in a wide variety of shapes. In addition to pouch-shaped and cylindrical battery cell housings, a prismatic battery cell housing is also often used. Prismatic battery cell housings consist of a battery cell housing jacket, which has a substantially rectangular cross section and thus enables a simple and space-saving arrangement of battery cells.

Currently, prismatic battery cell housings in the form of prismatic cups are predominantly manufactured by means of combined deep drawing and stretching processes with a multitude of drawing stages from a rolled product made from an aluminium alloy, for example a rolled product made from an aluminium alloy. In these processes, aluminium alloy AA3003 was previously used to manufacture the housing as an aluminium alloy with good deep-drawing properties. A large number of drawing steps are often required in the manufacturing processes.

Cylindrical battery cell housings essentially have the shape of a cylinder. If the height of the cylinder is greater than the diameter, they are referred to as round cells, otherwise as button cells. The cylindrical battery cell housings are also predominantly manufactured in a cup shape by means of deep drawing and/or pull-off drawing processes. Here, too, only the aluminium alloy AA3003 has been used thus far.

Alternative manufacturing processes for prismatic and cylindrical battery cell housings include extrusion, roll forming and sequential bending or chamfering. Impact extrusion uses slugs made from a rolled product, while roll forming uses consecutive working rolls or rollers to create a tube shape. In sequential bending (e.g. on presses), a sheet metal blank is formed into a tube shape in several bending operations. Regardless of the method, materially-bonded joining methods, in particular laser welding, must be used to seal the battery cell housings, which can include both sealing welding with one or more covers and longitudinal welding of a tube shape.

Another variant is the pouch design, in which the battery cell housing essentially has the shape of a pocket or pouch. Due to the high requirements for strength and mechanical stability as well as high requirements for electrochemical stability in relation to the electrolyte acting corrosively on the battery cell housing, cylindrical battery cell housings in particular have to date generally been manufactured from nickel-plated steel.

Aluminium alloy AA3003 is usually used for prismatic battery cell housings, as already described. United States patent application US 2006/093908 A1 discloses, for example, a high-strength battery housing which consists of a composite material having an outer plastic layer and an aluminium foil made of an aluminium alloy of type AA8079, 1N30, AA8021, AA3003, AA3004, AA3104 or AA3105.

The above-mentioned aluminium alloys are also known from Korean patent application KR 2016 0056731 A for deep-drawn battery cell housings of mobile phones, computers and other mobile end devices, wherein the Korean patent application also prefers the use of the aluminium alloy of type AA3003.

Japanese patent application JP 2015 125886 A focuses on the strength and weldability of the battery housings and proposes the use of aluminium alloys of type AA3003, AA3203, AA3004, AA3104, AA3005 or AA3105.

Although various Al—Mn alloys are known from the state of the art for the manufacture of battery cell housings, aluminium alloy AA3003 has prevailed in battery cell housing production. This is partly because secondary battery cell housings usually have to protect highly reactive chemicals from environmental influences. On the other hand, the battery cell housing itself must not be the cause of battery cell failures due to contamination, minute particles or shavings. This results in very high requirements for the processing properties of the rolled product made of an aluminium alloy that aluminium alloy AA3003 possesses. For example, forming tools in the production of battery cell housings are correspondingly elaborate and precisely adapted to the specific properties of the aluminium alloy of type AA3003. Adapting tools to aluminium alloys with different mechanical properties is costly and requires intensive development, and is made more difficult by already limited capacities.

On the other hand, the aluminium alloy AA3003 is only very well recyclable via a closed material cycle. However, closed material circuits are very complex and cost-intensive to implement, so the aluminium alloy AA3003 has a high proportion of primary aluminium. In addition, battery cells have a long service life of more than 10 years, so the return of the cell housing material can only be realised after long periods of time. The greatly increased sustainability requirements in recent years are requiring the production of battery cell housings with the smallest possible CO₂ footprint.

The most effective way is to reduce the use of energy-intensive primary aluminium by the increased use of recycled material, also referred to as secondary aluminium. This is obtained by melting aluminium scrap.

In the case of aluminium scrap, a distinction is made between pre-consumer scrap and post-consumer scrap. Pre-consumer scrap is waste which is generated during the manufacture of semi-finished products or end products made from aluminium or aluminium alloys in a wide variety of possible processes. Pre-consumer scrap may be further divided into internal process scrap on the one hand, which is unavoidably generated within the process of manufacturing aluminium strips or sheets, such as sprues, offcuts, swarf, production residues or production rejects, and external process scrap on the other hand, which is unavoidably generated in the further processing to form the end product, such as punching scrap, swarf or production rejects. Post-consumer scrap is an end product which has fully completed its life cycle and becomes waste after it has been used. It is irrelevant whether or not it was used by an end user, which means that it may also have been used in an industrial or commercial facility, for example. Examples of post-consumer scrap include food packaging, in particular beverage cans, window frames, lithographic printing plate carriers, cable cores and automotive components.

The use of recycled material is therefore hindered by the high safety requirements when processing rolled products made of aluminium alloys into battery cell housings.

The European patent application EP 2 527 479 A1, which originated from the applicant, merely discloses the use of aluminium alloy strip in general for electrically conductive products and, in particular, for busbars. The use of a rolled product for a battery cell housing is not known from the afore-mentioned European patent application.

### SUMMARY OF THE INVENTION

Based on this, the object of the present invention is therefore to propose a rolled product made of an aluminium alloy which guarantees a cost-effective use of secondary aluminium and simultaneously guarantees processing capability on existing production systems and tools for battery cell housings.

According to the present invention, the above-mentioned task is achieved with a rolled product made of an aluminium alloy for manufacturing a battery cell housing in such a way that the rolled product has an aluminium alloy with the following alloy components in % by weight:

$$0.1 \% \leq Si \leq 0.7 \% ,$$

$$0.2 \% \leq Fe \leq 0.8 \% ,$$

$$Cu \leq 0.6 \% ,$$

$$0.3 \% \leq Mn \leq 1.5 \% ,$$

$$0.025 \% < Mg < 0.6 \% , preferably 0.01 \% < Mg < 0.6 \% ,$$

$$Cr \leq 0.25 \% ,$$

$$Zn \leq 0.5 \% ,$$

$$Ti \leq 0.2 \% ,$$

the remainder being Al and unavoidable impurities, individually at most 0.05% and in total at most 0.15%,
wherein the rolled product has a tensile strength Rₘ of at least 135 MPa up to a maximum of 210 MPa, preferably a maximum of 185 MPa, a yield strength R_{p0.2} of more than 125 MPa up to a maximum of 180 MPa, preferably a maximum of 165 MPa, as well as an elongation A₅₀ of more than 5%, preferably more than 7%.

It has been shown that high proportions of recycled contents can lead to increased Si contents in the aluminium alloy. However, in combination with high Mg contents, the tendency of the aluminium alloy to hot crack increases significantly during welding. This reduces the process window when welding processes are used to manufacture battery cell housings significantly, so hot cracks can occur after welding. The same applies to the occurrence of welding pores, the formation of which is made more likely as the Mg content increases due to the low vapour pressure of Mg. The rolled product according to the invention with the above-mentioned composition allows the use of very high proportions of recycled contents during manufacturing. At the same time, the rolled product according to the invention has the mechanical properties of a rolled product of an aluminium alloy of type AA3003 in condition H14, whereby the production systems and tools previously used for rolled products made of an AA3003 alloy can be used for the new material. At the same time, due to the combination of the Si, Fe, Cu and Mg contents according to the invention, the rolled product is suitable for the manufacturing of battery cell housings using high proportions of recycled contents in the rolled product. This applies in particular to the use of UBC scrap (UBC: used beverage can), i.e. beverage cans made of aluminium alloys with significant magnesium and copper contents that are suitable for manufacturing the aluminium alloy of the rolled product of the battery cell housing. At the same time, a wide process window is provided for welding processes, as the tendency to hot crack and to form welding pores is reduced by the alloy composition.

All of the above-mentioned advantages are achieved by the alloy composition of the rolled product in combination with the specified mechanical properties for yield strength R_{p0.2}, tensile strength Rₘ and elongation A₅₀. Since the aluminium alloy furthermore contains only standard alloy elements, it can itself also be recycled well, so that the battery cell housing according to the invention may readily be added to existing scrap recycling operations. In addition, due to the alloy composition, the electrolyte resistance compared to the already known alloy AA3003 is not deteriorated or not significantly deteriorated, so economically and sustainably manufacturable battery cell housings can be provided.

According to the invention, the silicon content of the aluminium alloy lies in the range of 0.1 wt %≤Si≤0.7 wt %, thus allowing particularly high recycling rates. In one embodiment of the battery cell housing according to the invention, the silicon content of the aluminium alloy is in the range 0.2 wt %≤Si≤0.60 wt %, preferably 0.35 wt %≤Si≤0.55 wt %, more preferably 0.40 wt %≤Si≤0.50 wt %. In combination with the iron and manganese contents according to the invention in the amounts specified, the silicon content of 0.1 wt %≤Si≤0.7 wt % by weight leads in particular to relatively uniformly distributed, compact particles of the quaternary α-Al(Fe,Mn) Si phase. These precipitated particles increase both the strength of the aluminium alloy and its electrical and thermal conductivity, since they remove iron and manganese from the solid solution without detrimentally affecting other properties such as corrosion behaviour, i.e. the electrolyte stability, or formability. Silicon contents of less than 0.1 wt % lead to reduced precipitation of α-Al(Fe,Mn) Si phases, which may impair the electrical and thermal conductivity because of dissolved manganese. Furthermore, the absence of α-Al(Fe,Mn) Si phases has a detrimental effect on the tool wear. Silicon contents of more than 0.7% by weight may lead, in combination with magnesium, to the formation of Mg₂Si phases, which has a detrimental effect on the solid solution hardening of magnesium. The silicon content of the preferred embodiment of 0.2 wt %≤Si≤0.60 wt %, preferably 0.35 wt %≤Si≤0.55 wt % and 0.40 wt %≤Si≤0.50 wt % represents an ideal compromise between high strength and high electrical and thermal conductivity when providing wide process windows for welding.

According to the invention, the iron content of the aluminium alloy is in the range 0.2 wt %≤Fe≤0.8 wt %. In one embodiment of the rolled product according to the invention, the iron content of the aluminium alloy is in the range 0.2 wt %≤Fe≤0.65 wt %, preferably 0.25 wt %≤Fe≤0.55 wt %. The iron content of 0.2 wt %≤Fe≤0.8 wt % in combination with the manganese content according to the invention in the amount specified leads to the formation of Al₆(Mn,Fe) phases, and, as already explained above, in combination with the silicon and manganese contents according to the invention in the amounts specified to the precipitation of particles of the quaternary α-Al(Fe,Mn) Si phase. Iron in this case contributes to lowering the solubility of manganese in aluminium, so that more manganese is bound in intermetallic phases, which has a positive effect on the electrical and thermal conductivity. Moreover, the intermetallic phases influence recovery and recrystallisation processes and improve the thermal stability of the mechanical properties. Iron contents of more than 0.8 wt % promote the formation of coarse intermetallic phases, which may impair the formability in the deep drawing process. Iron contents of less than 0.2 wt %, on the other hand, limit the tolerance of the aluminium alloy for ferrous scrap too greatly since conventional scrap grades generally have a significant proportion of iron. Limiting the iron content too greatly may therefore hinder the achievement of high recycling rates. The corridor of the iron content of the aforementioned embodiment of 0.2 wt %≤Fe≤0.65 wt %, preferably 0.25 wt %≤Fe≤0.55 wt %, therefore represents an ideal combination of recyclability, use of high proportions of recycled material, thermal stability, electrical and thermal conductivity and formability.

According to the invention, the copper content of the aluminium alloy is in the range Cu≤0.6 wt %. In one embodiment of the rolled product according to the invention, the copper content of the aluminium alloy is in the range Cu≤0.3 wt %, preferably 0.1 wt %≤Cu≤0.2 wt %, particularly preferably 0.10 wt %≤Cu≤0.20 wt %. The fact that a copper content of up to 0.6 wt % is permitted results in an increased tolerance of the aluminium alloy for copper-containing aluminium alloy scrap, which promotes the achievement of high proportions of recycled material in the manufacture of the battery housing. However, since excessively high copper contents may have a detrimental effect on the corrosion properties, the copper content is limited according to the invention to at most 0.6 wt % in order to achieve a sufficiently high electrolyte stability. For improved electrolyte stability and sufficiently high electrical and thermal conductivity, the copper content in the aforementioned embodiment is limited to 0.3 wt %. However, the presence of copper also causes an increase in the strength of the aluminium alloy by solid solution hardening, although this only becomes significant above a content of 0.1 wt %. A preferred range of 0.1 wt %≤Cu≤0.2 wt % or 0.10 wt %≤Cu≤0.20 wt % therefore represents a compromise between high strength, sufficiently high electrical and thermal conductivity and further improved electrolyte stability with sufficient recycling tolerance.

According to the invention, the manganese content of the aluminium alloy is in the range 0.3 wt %≤Mn≤1.5 wt %. In one embodiment of the rolled product according to the invention, the manganese content of the aluminium alloy is in the range 0.3 wt %≤Mn≤1.4 wt %. As already explained above, the manganese content of 0.4 wt %≤Mn≤1.3 wt %, preferably 0.6 wt %≤Mn≤1.1 wt %, leads in combination with the silicon and iron contents in the amounts specified to the precipitation of particles of the quaternary α-Al(Fe,Mn) Si phase as well as the Al₆(Mn,Fe) phase. The intermetallic phases hinder recovery and recrystallisation processes and therefore improve the thermal stability of the mechanical properties. Manganese contents of less than 0.3% by weight result in only a very slight increase in strength due to dispersoid and solid solution strengthening, so at least 0.3% by weight of manganese is provided. From manganese contents of at least 0.4% by weight, significant strength increases are achieved by dispersoid and solid solution strengthening, which are even stronger from at least 0.6% by weight of manganese. Manganese contents of more than 1.5 wt % promote the formation of coarse intermetallic phases, which have an unfavourable effect on the forming properties in the deep drawing process. Furthermore, manganese contents of more than 1.5 wt % reduce the electrical and thermal conductivities of the rolled products to such an extent that the battery cell housings made from them become inefficient. The Mn content is therefore preferably a maximum of 1.5 wt %, preferably a maximum of 1.3 wt %, particularly preferably a maximum of 1.1 wt %. According to a further embodiment, the Mn/Si ratio is preferably greater than 0.8, since the formation of an α-Al(Fe,Mn) Si phase is promoted starting at this ratio.

According to the invention, the magnesium content of the aluminium alloy lies in the range 0.0025 wt %≤Mg≤0.60%, preferably in the range 0.01 wt %≤Mg≤ 0.60%. In one embodiment of the battery cell housing according to the invention, the magnesium content of the aluminium alloy lies in the range 0.05 wt %≤Mg≤0.55 wt %, preferably 0.10 wt %≤Mg≤0.45 wt %. The fact that a magnesium content of up to 0.60 wt % is permitted results in a tolerance of the aluminium alloy for magnesium-containing aluminium alloy scrap such as packaging UBC scrap, which further promotes the achievement of high proportions of recycled material in the manufacture of the battery cell housings. At the same time, limiting the Mg content to 0.60% by weight allows higher Si contents to be permitted without the aluminium alloy being prone to hot cracking and the formation of welding pores when welding the rolled product. In addition, the presence of magnesium from a content of at least 0.0025 wt %, preferably at least 0.05 wt %, particularly preferably more than 0.05 wt % or more preferably at least 0.10 wt % leads to solid solution hardening, which contributes to increased cold hardening and thus a higher strength can be provided. To achieve improved mechanical properties while providing optimal process windows for welding processes, the magnesium content is limited to preferred ranges of 0.05 wt %≤Mg≤0.55 wt %, preferably 0.05 wt %≤Mg≤0.50 wt % or particularly preferably to 0.10 wt %≤Mg≤0.45 wt % and a compromise is achieved between high strength, good forming characteristics and high electrical and thermal conductivity with good recycling tolerance and weldability.

According to the invention, the chromium content of the aluminium alloy is in the range Cr≤0.25 wt %. In one embodiment of the rolled product according to the invention, the chromium content of the aluminium alloy is in the range Cr≤0.1 wt %, preferably Cr≤0.05 wt %. The fact that a chromium content of up to 0.25 wt % is permitted results in an increased tolerance of the aluminium alloy for chromium-containing aluminium alloy scrap, which promotes the achievement of high proportions of recycled material in the manufacture of the rolled product according to the invention. In addition, chromium also has a strength-increasing effect and forms dispersoids, which increase the thermal stability and hinder softening due to recrystallisation or recovery. However, since excessively high chromium contents may have a detrimental effect on the electrical conductivity of the aluminium alloy, the chromium content is limited according to the invention to at most 0.25 wt %. For improved conductivity with a recycling tolerance and strength that are still sufficient, the chromium content in the afore-mentioned embodiment is limited to 0.1 wt %, preferably 0.05 wt %.

According to the invention, the zinc content of the aluminium alloy is in the range Zn≤0.5 wt %. In one embodiment of the rolled product according to the invention, the zinc content of the aluminium alloy is in the range of 0.0050 wt %≤Zn≤0.30 wt %, preferably 0.02 wt %≤Zn≤0.30 wt %, more preferably 0.04 wt %≤Zn≤0.25 wt %. The fact that a zinc content of up to 0.5 wt % is permitted results in an increased tolerance of the aluminium alloy for zinc-containing aluminium alloy scrap, which further promotes the achievement of high recycling rates. Zinc also has a strength-increasing effect. However, since excessively high zinc contents reduce the weldability, the electrical and thermal conductivity as well as the corrosion resistance of the aluminium alloy, the zinc content is limited according to the invention to at most 0.5 wt %. In the aforementioned embodiment, the zinc content is adjusted within the corridor 0.0050 wt %≤Zn≤0.30 wt %, preferably 0.02 wt %≤Zn≤0.30 wt %, more preferably 0.04 wt %≤Zn≤0.25 wt % so an optimal compromise between high strength, good weldability and good electrolyte stability is achieved with a recycling tolerance which remains good.

According to the invention, the titanium content of the aluminium alloy is in the range Ti≤0.2 wt %. In one embodiment of the rolled product according to the invention, the titanium content of the aluminium alloy is in the range 0.005 wt %≤Ti≤0.1 wt %, preferably 0.005 wt %≤Ti≤0.05 wt %. The fact that a titanium content of up to 0.2 wt % is permitted results in an increased tolerance of the aluminium alloy for titanium-containing aluminium alloy scrap, which promotes the achievement of high proportions of recycled material in the manufacture of battery cell housings. However, excessively high titanium contents may detrimentally affect the forming properties of the aluminium alloy and significantly reduce the electrical and thermal conductivity, so that the titanium content is limited according to the invention to at most 0.2 wt %. Conversely, titanium above a content of 0.005 wt % improves the grain refinement when casting the aluminium alloy. For good grain refinement together with good formability, sufficiently high electrical and thermal conductivity as well as sufficient recycling tolerance, the titanium content in the aforementioned embodiment is therefore adjusted within the corridor 0.005 wt %≤Ti≤0.1 wt %, preferably 0.005 wt %≤Ti≤0.05 wt %.

In addition to the alloy constituents mentioned above, the remainder of the aluminium alloy of the rolled product according to the invention consists of aluminium and unavoidable impurities. Unavoidable impurities are alloy constituents which are not intentionally added but are inevitably contained in the aluminium alloy due to manufacturing. According to the invention, the content of an individual unavoidable impurity is limited to 0.05 wt %, the content of all unavoidable impurities being limited in total to 0.15 wt %. This ensures that the unavoidable impurities have no detrimental effect, or no significant detrimental effects, on the properties of the aluminium alloy, for example by undesired phase formation.

It has emerged that, despite the deviations in the chemical composition of the rolled product made of an aluminium alloy with the above-mentioned contents of alloy components, a combination of mechanical properties of the rolled product can be achieved that meet the high requirements for processing the rolled product into the battery cell housing of the aluminium alloy AA3003 and the rolled product can be processed in production facilities provided for this purpose. This enables battery cell housings with a low CO₂ footprint to be produced sustainably in existing production facilities.

According to a further embodiment, the proportion of recycled metal in the rolled product made from an aluminium alloy is at least 30% by weight, preferably at least 50% by weight, particularly preferably at least 70% by weight or particularly preferably at least 75% recycled material. Due to the high recycling tolerance of the aluminium alloy of the rolled product described above, the realisation of these high recycling proportions for the rolled product according to the invention is made possible without negatively impacting the process parameters for preferred manufacturing methods such as the welding method.

The associated energy saving allows the production of battery cell housings with the smallest possible CO₂ footprint and improved sustainability. The recycled material in the rolled product preferably makes up a proportion of at least 30% by weight, preferably at least 50% by weight, particularly preferably at least 70% by weight of post-consumer scrap. As post-consumer scrap is only generated at the end of the product life cycle, it is considered particularly sustainable and contributes more to reducing the CO₂ footprint. Cumulatively or alternatively, the recycled material makes up a proportion of at least 30% by weight, preferably at least 50% by weight, particularly preferably at least 70% by weight or at least 75% pre-consumer scrap, or internal and/or external process scrap. With internal process scrap, the compositions and amounts of the individual alloys are generally very well known, so that the alloy composition resulting from the melting of internal process scrap can be determined well. External process scrap is less well defined in its composition than internal process scrap and may require further processing steps, but is generated to a large extent for example in the production of punched parts, so that recycling is of high relevance economically and in terms of sustainability. By recycling external process scrap, the need for primary metal can be reduced, which reduces the overall CO₂ balance. Even if the embodiments described later have a maximum proportion of recycled material of 85%, proportions of recycled material of at least 90% can also be achieved with the aluminium alloy composition according to the invention.

According to a further embodiment of the rolled product, this has the tempering state H12, H22, H24, H34 or H32. It has been proven that even rolling-hard rolled products in the H12 state enable the mechanical specifications with regard to processability in the same way as a rolled product made from an aluminium alloy of type AA3003. The reheated states H22, H24, H32, H34 also demonstrate the advantage of improved formability.

If the rolled product made of an aluminium alloy according to a further embodiment of the battery cell housing has a thickness between 0.1 mm and 2.0 mm, the wall thicknesses typical for a battery cell housing can be completely covered. Reducing the thickness to less than 0.1 mm decreases the mechanical stability of the battery cell housing too greatly. Conversely, efficient use of material is no longer possible with a thickness of more than 2.0 mm. In addition, the gravimetric and volumetric energy density of the battery cell or battery module, or battery system, would be reduced too greatly if the rolled product of the battery cell housing were to have a thickness of more than 2.0 mm. Preferably, the thickness of the rolled product or sheet is between 0.25 mm and 1.5 mm, in particular between 0.35 mm and 1.2 mm.

According to a further embodiment, the rolled product preferably has a degreased surface with surface stresses of more than 30 mN/m, preferably more than 32 mN/m, particular preferably 34 mN/m, so the weldability of the rolled product for manufacturing a battery cell housing is improved by this. The surface tension of the surface of the rolled product can be achieved, for example, by alkaline or acid degreasing or pickling and measured with good accuracy using test inks.

According to the invention, the above object is also achieved by a method for manufacturing a rolled product from an aluminium alloy with the following process steps:
Provision of a rolling ingot made of an aluminium alloy with the following composition in % by weight:

$$0.1 \% \leq Si \leq 0.7 \% ,$$

$$0.2 \% \leq Fe \leq 0.8 \% ,$$

$$Cu \leq 0.6 \% ,$$

$$0.3 \% \leq Mn \leq 1.5 \% ,$$

$$0.025 \% < Mg < 0.6 \% , preferably 0.05 \% < Mg < 0.55 \% ,$$

$$Cr \leq 0.25 \% ,$$

$$Zn \leq 0.5 \% ,$$

$$Ti \leq 0.2 \% ,$$

the remainder being Al and unavoidable impurities, individually at most 0.05% and in total at most 0.15%,
optional homogenising of the rolling ingot at 480° C. to 625° C., preferably at 550° C. to 620° C. for at least 0.1 hours, preferably for at least 0.25 hours, preferably for at least 0.5 hours,
Hot rolling of the rolling ingot to a hot strip thickness of 2 mm to 10 mm with a final hot strip temperature of between 250° C. and 450° C.,
Cold rolling of the hot strip at the final thickness with at least one optional intermediate annealing in the form of soft annealing at 250° C. and 450° C., whereby the degree of rolling during cold rolling after hot rolling or after the last intermediate annealing at the final thickness is less than 25%, preferably less than 22% or particularly preferably less than 18%.

The aforementioned process steps are preferably carried out in the order specified, in which case the homogenisation of the rolling ingot may be carried out separately or may be integrated into the preheating of the rolling ingot for the hot rolling. It has been determined that with the method described above, it is possible to manufacture a rolled product made of an aluminium alloy, with which the requirements of a battery cell housing, in particular with regard to strength, electrolyte stability and electrical and thermal conductivity with good weldability, can be achieved when used according to the invention and at the same time high recycling rates can be achieved. Furthermore, this process allows economical manufacture of the rolled product.

The casting of the rolling ingot from an aluminium alloy is preferably carried out in direct-chill continuous casting, also referred to as DC continuous casting, so that the economical viability of the manufacturing process may be further increased.

By homogenising the rolling ingot, an improvement of the microstructure of the rolled product is achieved, which has a positive effect on strength and formability. The grain structure is refined by homogenisation in an otherwise identical manufacturing process. As a result, a reduced average grain size is obtained in the final product after cold rolling, thus improving formability. The homogenization preferably takes place at a temperature of 480° C. to 625° C., preferably at 550° C. to 620° C. for at least 0.1 hours, preferably for at least 0.25 hours or preferably for at least 0.5 h, more preferably for at least 1 h or 2 h.

The preheating temperature at the start of the hot rolling is preferably between 39° and 550° C. The hot rolling of the rolling ingot to a hot rolled strip takes place in such a way that the final temperature of the hot strip is between 250° C. and 450° C., wherein the final temperature of the hot strip after the last hot rolling pass is preferably between 280° C. and 380° C., preferably between 310° C. and 360° C. The hot rolling of the rolling ingot may take place either reversibly on one roll stand or sequentially in a tandem stand. In particular, the hot rolling may take place reversibly as far as a slab thickness between 20 mm and 50 mm and the slab may then be rolled to hot strip thickness in a tandem stand. The hot strip thickness, i.e. the thickness of the hot-rolled strip, is 2 mm and 10 mm. This ensures that a sufficiently high degree of rolling can be set during the subsequent cold rolling, which primarily determines the strength and formability of the rolled product.

Cold rolling of the rolled product can be done in one or several passes. In an embodiment of the method in which several cold rolling passes are carried out, at least one intermediate anneal is optionally carried out during the cold rolling. In one embodiment of the method, the intermediate anneal takes place in the temperature range between 250° C. and 450° C., preferably between 280° C. and 400° C., in particular between 300° C. and 400° C. The intermediate annealing is preferably carried out as a recrystallisation anneal by which a recrystallised microstructure is provided for the subsequent cold rolling pass. This cold rolling pass may then be carried out with a higher rolling ratio, which has a strength-increasing effect on the finished rolled product made of an aluminium alloy. All of the temperature specifications mentioned which identify annealing processes always refer to peak metal temperatures (PMT), i.e. the highest temperatures of the metal in the annealing furnace.

According to the invention, the degree of rolling during cold rolling after hot rolling or after the last intermediate annealing at final thickness is less than 25%, preferably less than 22% or particularly preferably less than 18%. The low degree of rolling in combination with the preceding process steps and the composition of the aluminium alloy of the rolled product ensures that the rolled product has the desired strengths with a yield strength of R_{p0.2} of more than 125 MPa to a maximum of 180 MPa, a tensile strength Rₘ of at least 135 MPa to a maximum of 185 MPa for processing to the battery cell.

Alternatively, the method according to a further embodiment can be configured in that after hot rolling, cold rolling is only carried out at final thickness with at least one optional intermediate annealing in the form of a soft annealing at 250° C. and 450° C., wherein final annealing takes place in a temperature range of 150° C. to 280° C. for setting back-annealed structural states in the rolled product at final thickness. In this embodiment, degrees of rolling of at least 50% or more after the last intermediate annealing are preferably used in order to enable a homogeneous and fine-grained structure through the final annealing.

Intermediate annealing takes place at the specified temperature for at least as long as is necessary to achieve a soft annealed state of the cold-rolled strip after intermediate annealing. Among other things, this also depends on the furnace technology selected, i.e. whether a continuous flow furnace or a chamber furnace is used.

The rolled product according to the invention is preferably used for the manufacture of a battery cell housing, wherein the rolled product is preferably manufactured using a method according to the invention. As already stated above, the use of the rolled product according to the invention for the manufacture of battery cell housings allows a high recycling proportion to be taken into account in the rolled product without having to change or renew the properties of the battery cell housing or the production equipment required for processing. Unlike before, the use according to the invention leads to highly sustainable battery cell housings with a low CO₂ footprint.

This result is achieved by using the rolled product according to the invention for battery cell housings of a secondary cell, preferably a lithium ion secondary cell, a sodium ion secondary cell or a solid state secondary cell.

According to a further embodiment of the use according to the invention, the battery cell housing has a prismatic design, a cylindrical design or a pouch design. All three uses benefit from the aluminium alloy composition of the rolled product in combination with the mechanical properties of the possibility of using high proportions of recycled contents in the aluminium alloy, unlike previously, with unchanged processing properties.

If, according to an embodiment of use, the rolled product is subjected to a plurality of forming steps, wherein preferably deep drawing and/or wall-ironing is carried out, existing production facilities for manufacturing the battery cell housings from a production based on an aluminium alloy AA3003 can also be used for the rolled product according to the invention. This saves high investment costs.

The invention also relates to a battery cell housing manufactured from a rolled product according to the invention, wherein the battery cell housing has a prismatic design shape, a cylindrical design shape or a pouch design shape, which can now also be manufactured with a low CO₂ footprint without a complex material cycle.

According to a further embodiment of the battery cell housing, the battery cell housing has formed regions which are obtained by forming, preferably by deep drawing and/or wall-ironing of a rolled product. The corresponding forming can be carried out on existing production equipment despite the different material compositions compared to aluminium alloy AA3003.

### BRIEF DESCRIPTION OF THE DRAWINGS

The invention is described in greater detail below using exemplary embodiments in connection with the drawing. In the drawing,

FIG. 1 shows a schematic representation of a battery cell of cylindrical design with a battery cell housing according to the invention,

FIG. 2 shows a schematic representation of a battery cell of prismatic design with a battery cell housing according to the invention,

FIG. 3 shows a schematic representation of a battery cell in pouch design with a battery cell housing according to the invention,

FIG. 4 shows a flowchart of a method for manufacturing a rolled product from an aluminium alloy for battery cell housings and

FIG. 5 shows a flowchart of a method for manufacturing battery cell housings from rolled products made of an aluminium alloy comprising deep drawing and/or wall-ironing process steps.

### DETAILED DESCRIPTION

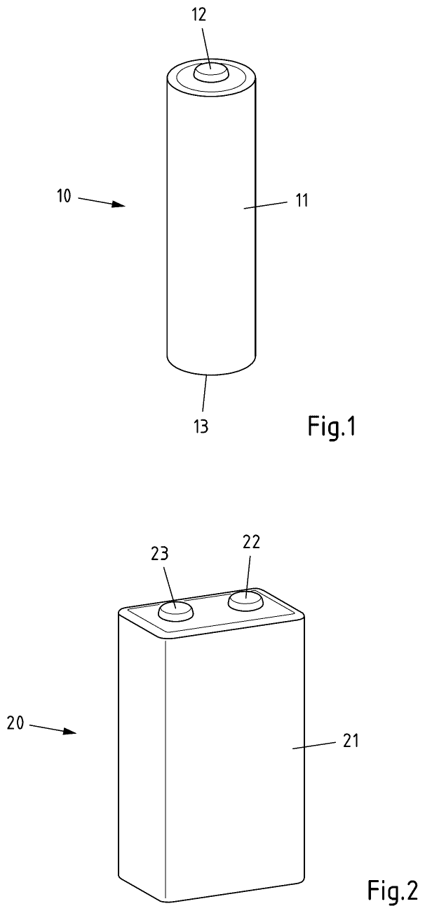

FIG. 1 shows an embodiment of a battery cell 10 with a cylindrical design in a schematic representation. The battery cell 10 has a battery cell housing 11 according to the invention and, adjacent thereto, an anode terminal 12 and a cathode terminal 13. The battery cell housing 11 can for example consist of a cylindrical cup with cathode terminal 13 and a battery cell housing cover with anode terminal 12.

FIG. 2 shows a battery cell 20 of prismatic design in a schematic representation. The battery cell 20 has a battery cell housing 21 according to the invention and, adjacent thereto, an anode terminal 22 and a cathode terminal 23. The prismatic battery cell housing 21 can also consist, for example, of a prismatic cup and a battery cell housing lid with the anode and cathode terminal 22 and 23.

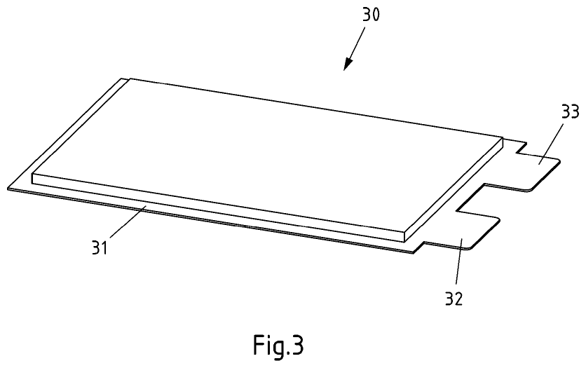

FIG. 3 shows an embodiment of a battery cell 30 in a pouch design in a schematic representation. The battery cell 30 has a battery cell housing 31 according to the invention and, adjacent thereto, an anode terminal 32 and a cathode terminal 33.

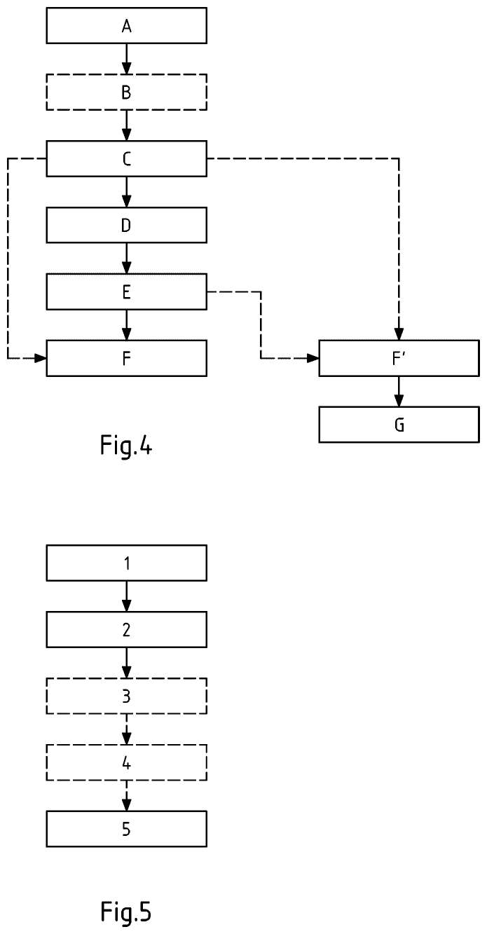

FIG. 4 now shows a flowchart of an exemplary embodiment of a method according to the invention for manufacturing a rolled product according to the present invention.

In step A, the method comprises providing a rolling ingot made of an aluminium alloy. This is usually done using the DC casting method. The aluminium alloy has the following composition in % by weight:

$$0.1 \% \leq Si \leq 0.7 \% ,$$

$$0.2 \% \leq Fe \leq 0.8 \% ,$$

$$Cu \leq 0.6 \% ,$$

$$0.3 \% \leq Mn \leq 1.5 \% ,$$

$$0.025 \% < Mg < 0.6 \% , preferably 0.01 \% < Mg < 0.6 \% ,$$

$$Cr \leq 0.25 \% ,$$

$$Zn \leq 0.5 \% ,$$

$$Ti \leq 0.2 \% ,$$

the remainder being Al and unavoidable impurities, individually at most 0.05% and in total at most 0.15%.

Preferably, however, the aluminium alloy may also have the following composition:

$$0.2 \% \leq Si \leq 0.6 \% , preferably 0.35 \% \leq Si \leq 0.55 \% ,$$

$$0.2 \% \leq Fe \leq 0.65 \% , preferably 0.25 \% \leq Fe \leq 0.55 \% ,$$

$$Cu \leq 0.3 \% , preferably 0.1 \% \leq Cu \leq 0.2 \% ,$$

$$0.3 \% \leq Mn \leq 1.3 \% , preferably 0.4 \% \leq Mn \leq 1.1 \% ,$$

$$0.05 \% \leq Mg \leq 0.5 \% , preferably 0.1 \% \leq Mg \leq 0.45 \% ,$$

$$Cr \leq 0.1 \% , preferably Cr \leq 0.05 \% ,$$

$$0.005 \% \leq Zn \leq 0.3 \% , preferably 0.02 \% \leq Zn \leq 0.3 \% , or preferably$$

$$0.04 \% \leq Zn \leq 0.25 \% ,$$

$$0.005 \% \leq Ti \leq 0.1 \% , preferably 0.005 \% \leq Ti \leq 0.05 \% ,$$

the remainder being Al and unavoidable impurities, individually at most 0.05% and in total at most

$$0.15 \% .$$

In step B, the rolling ingot manufactured in this way is optionally homogenised for at least 0.1 hours, preferably at least 0.25 hours or preferably at least 0.5 hours at a temperature of 480° C. to 625° C., preferably at 550° C. to 620° C. Homogenisation can be integrated into the preheating process of the rolling ingot before hot rolling or be carried out separately.

In step C, the rolling ingots are hot rolled to a hot strip final thickness of 2 mm to 10 mm with a hot strip final temperature between 250° C. and 450° C. In principle, however, the method according to the invention can also comprise recrystallization annealing after hot rolling, which is not shown in FIG. 4.

Cold rolling of the hot strip is carried out in FIG. 4 according to step D after hot rolling. During the cold rolling according to step D, at least one optional intermediate annealing in the form of a soft annealing can be carried out at temperatures from 250° C. to 450° C. according to step E. After the last intermediate annealing, cold rolling is performed at a final thickness according to step F. If no intermediate annealing is performed, step F replaces steps D and E and cold rolling is performed without intermediate annealing at final thickness.

In step F, the degree of rolling during cold rolling after hot rolling or after the last intermediate annealing at final thickness is limited to less than 25%, preferably less than 22% or particularly preferably less than 18% in order to obtain the necessary rolled product properties.

Alternatively, after hot rolling, cold rolling at final thickness with at least one optional intermediate annealing in the form of soft annealing at 250° C. and 450° C. according to steps D, E and F′ may be carried out. Unlike F, cold rolling at final thickness according to step F′ is not limited to a maximum degree of rolling. Instead, rolling rates of at least 25% or preferably at least 28% are used. In this alternative, the setting of re-annealed structural states in the rolled product at the final thickness is achieved by means of a final annealing in a temperature range of 150° C. to 280° C. according to step G, so the desired properties are achieved in this way. During the final annealing, the target metal temperature is maintained for at least 0.5 hours, preferably at least 1 hour.

To manufacture the battery cell housings 11, 21, 31, a rolled product made of an aluminium alloy undergoes several forming steps. FIG. 5 shows a schematic flow chart representation of the manufacture of a cup-shaped battery cell housing, for example of cylindrical or prismatic battery cell housings, starting from a rolled product in the form of a strip or sheet. The rolled product is provided in step 1 and formed in a first forming step, for example by a first deep drawing step according to step 2. Further optional deep drawing or wall-ironing steps 3, 4 can follow until a cup-shaped battery cell housing can be provided in step 5. This can then undergo further work steps up to the finished battery cell.

Due to high safety requirements for battery cell housings, the forming steps are carried out using production equipment specifically tailored to the selected aluminium alloy. The production equipment currently mainly used is adapted to rolled products consisting of an aluminium alloy of type AA3003.

Embodiments of the rolled product according to the invention and rolled products as comparative examples were manufactured from different aluminium alloys and their suitability for use in the production equipment mentioned was tested. It is assumed that the rolled products are suitable for use in the production equipment that is predominantly available for an aluminium alloy of type AA3003 when the specified mechanical characteristics for the yield strength R_{p0.2}, tensile strength Rₘ and elongation A₅₀ are reached.

Table 1 initially shows the alloy compositions of the exemplary embodiments (inv.) and the comparative examples (comp.). Each individual example was manufactured with the specific process parameters specified in Table 2. All temperature specifications are understood as “peak metal temperature” (PMT), i.e. the maximum temperature of the metal. During homogenisation, the dwell time at the homogenisation temperature was at least 1 h. Homogenisation can take place in a separate annealing process or can be integrated into the preheating. In the case of homogenisation integrated into the preheating, the homogenisation temperature is initially set and maintained for at least 1 h. The rolling ingots are then brought to preheating temperature. When preheating the rolling ingot, the rolling ingot is fed into the rolling process when the preheating temperature is reached. In all examples, the preheating temperature at the start of hot rolling was between 39° and 550° C. Hot strip thickness is understood to be the final hot strip thickness. Hot strip temperature refers to the final hot strip temperature, i.e. the temperature of the hot strip after the last hot rolling pass.

Finally, the mechanical properties achieved are shown in Table 3. All mechanical parameters such as yield strength R_{p0.2}, tensile strength Rₘ and elongation A₅₀ were obtained in accordance with EN ISO 6892-1:2019.

Comparative example No. 3 corresponds to a reference rolled product made of an aluminium alloy of type AA3003. Examples No. 1, 6 to 8 and 11 to 12 are rolled products according to the teaching of the invention. These have an aluminium alloy, which, in contrast to the primary aluminium-based reference rolled product No. 3, allows high proportions of recycled contents.

Embodiment No. 1 was manufactured in the state H12, i.e. without reverse annealing. The rolling ingots were homogenised in accordance with the above specifications. The degree of rolling of the final thickness after intermediate annealing was 12%. Embodiment No. 1 achieves the mechanical values according to the invention and can be manufactured both with high proportions of recycled contents and used on the production equipment of existing battery cell housing productions due to the composition.

Although example No. 2 manufactured from an identically homogenised rolling ingot has an aluminium alloy with the characteristics of claim 1, the rolled product was cold rolled with an excessively high degree of rolling at a final thickness of 30% after the intermediate annealing. As a result, the reference rolled product produced in this way does not achieve the desired mechanical properties. It has significantly an excessive strength and has insufficient elongation A₅₀.

Although reference material No. 3 achieves all the mechanical characteristics, as already stated, it can only be produced by closed material cycles with a high proportion of recycled material of at least 30%.

The rolled products according to comparative examples No. 4 and No. 5 have magnesium contents that are significantly too high and therefore tend to have a pronounced cold hardening during cold rolling. The cold hardening was so high that it could not be sufficiently decomposed even during the reheating processes carried out at 180° C. for 16 h and at 250° C. for 1 h. Comparative examples No. 4 and 5 therefore cannot be used on the current production equipment for the production of battery cell housings.

Embodiments No. 6 to 8 have two different alloy compositions, wherein embodiments No. 6 and 7 have identical compositions. All three exemplary embodiments were manufactured with different manufacturing methods according to the present invention and achieve the claimed mechanical characteristic values in the states H22 (No. 6 and 7) and H24 (No. 8).

The rolled product of comparative example No. 9 has an aluminium alloy with a composition that corresponds to the required contents. In cold rolling after intermediate annealing, the degree of rolling at the final thickness was 30%, so the mechanical characteristic values of the invention were not achieved. The rolled product showed too little elongation A₅₀ and too high a tensile strength Rₘ. Further processing on existing production equipment for the production of battery cell housings is therefore not possible.

Comparative example No. 10 also has an aluminium alloy according to the present invention but was transferred to the soft state O in the final annealing, so comparative example No. 10 also does not meet the requirement for the manufacture of battery cell housings.

Embodiments No. 11 and No. 12 have an aluminium alloy composition according to the invention and were manufactured using manufacturing methods according to the invention. The corresponding rolled products in the re-annealed states H24 and H22 exhibited all the required mechanical characteristics and can be used on existing production equipment for the manufacture of battery cell housings.

TABLE 1

| No | | Si | Fe | Cu | Mn | Mg | Cr | Zn | Ti |
|---|---|---|---|---|---|---|---|---|---|
| 1 | Invention | 0.44 | 0.46 | 0.12 | 1.02 | 0.48 | 0.01 | 0.01 | 0.01 |
| 2 | Comparison | 0.48 | 0.56 | 0.14 | 1.01 | 0.51 | 0.02 | 0.04 | 0.03 |
| 3 | Comparison | 0.18 | 0.58 | 0.19 | 1.02 | 0.02 | <0.01 | <0.01 | 0.01 |
| 4 | Comparison | 0.24 | 0.53 | 0.17 | 0.85 | 1.04 | 0.02 | 0.05 | 0.02 |
| 5 | Comparison | 0.24 | 0.53 | 0.17 | 0.85 | 1.04 | 0.02 | 0.05 | 0.02 |
| 6 | Invention | 0.52 | 0.53 | 0.20 | 1.17 | 0.43 | 0.03 | 0.25 | 0.02 |
| 7 | Invention | 0.52 | 0.53 | 0.20 | 1.17 | 0.43 | 0.03 | 0.25 | 0.02 |
| 8 | Invention | 0.53 | 0.63 | 0.15 | 0.63 | 0.32 | 0.02 | 0.11 | 0.01 |
| 9 | Comparison | 0.45 | 0.61 | 0.63 | 1.20 | 0.32 | 0.04 | 0.12 | 0.01 |
| 10 | Comparison | 0.23 | 0.51 | 0.08 | 0.42 | 0.30 | 0.01 | 0.03 | 0.01 |
| 11 | Invention | 0.34 | 0.42 | 0.14 | 0.68 | 0.31 | 0.01 | 0.03 | 0.01 |
| 12 | Invention | 0.47 | 0.44 | 0.14 | 1.05 | 0.47 | 0.04 | 0.02 | 0.02 |

*All data in wt %, the remainder being aluminium and unavoidable impurities, individually at most 0.05 wt % and in total 0.15 wt %

TABLE 2

| | | P: | | Hot | | | | | |
|---|---|---|---|---|---|---|---|---|---|
| | | preheating | Hot | Strip | Thickness | | Degree | | |
| | | H: homo- | Strip | final | Intermediate | Intermediate | of | Final | Final |
| | | genisation | thickness | temp. | annealing | annealing | rolling | thickness | annealing |
| Method | | [° C.] | [mm] | [° C.] | [mm] | [° C.] | [%] | [mm] | [° C.] |
| 1 | Invention | H: 600 | 6.5 | 330- | 1.14 | 320 | 12 | 1 | — |
| | | | | 370 | | | | | |
| 2 | Comparison | H: 600 | 6.5 | 330- | 1.11 | 320 | 30 | 0.78 | — |
| | | | | 370 | | | | | |
| 3 | Comparison | H: 600 | 4 | 330 | 1.08 | 360 | 17 | 0.9 | — |
| 4 | Comparison | H: 600 | 2.3 | 340 | — | — | 62 | 0.89 | 180 |
| 5 | Comparison | H: 600 | 2.3 | 340 | — | — | 62 | 0.89 | 250 |
| 6 | Invention | V: 565 | 3.5 | 280- | — | — | 67 | 1.15 | 275 |
| | | | | 310 | | | | | |
| 7 | Invention | V: 565 | 3.5 | 280- | — | — | 80 | 0.7 | 275 |
| | | | | 310 | | | | | |
| 8 | Invention | V: 565 | 3.5 | 280- | — | — | 83 | 0.61 | 260- |
| | | | | 310 | | | | | 270 |
| 9 | Comparison | V: 565 | 3.5 | 280- | 1.14 | 345 | 30 | 0.8 | — |
| | | | | 310 | | | | | |
| 10 | Comparison | V: 565 | 5 | 280- | — | — | 88 | 0.6 | 300- |
| | | | | 310 | | | | | 345 |
| 11 | Invention | V: 565 | 4.5 | 280- | — | — | 80 | 0.89 | 260- |
| | | | | 310 | | | | | 270 |
| 12 | Invention | V: 510 | 6.5 | 330 | 0.82 | 320 | 20 | 0.66 | 240 |
| | | | | 370 | | | | | |

TABLE 3

| | | | | | | | Proportion | |
|---|---|---|---|---|---|---|---|---|
| | | | | | | | of recycled | |
| | | | | | | | metal | |
| | | | | | | | (Sum of | |
| | | | | | | | internal + | |
| | | | | | | | external | |
| | | | Thickness | Rp02 | Rm | A50 | scrap) | |
| Results | | State | [mm] | [MPa] | [MPa] | [%] | [%] | Comments |
| 1 | Invention | H12 | 1 | 149 | 157 | 8 | 44 | OK |
| 2 | Comparison | H14 | 0.78 | 190 | 200 | 2.8 | 95 | Too solid, |
| | | | | | | | | too little |
| | | | | | | | | elongation |
| 3 | Comparison | H14 | 0.9 | 143 | 146 | 11.7 | 10 | Reference |
| | | | | | | | | (AA3003) |
| 4 | Comparison | H24 | 0.89 | 241 | 276 | 7.4 | 89 | Too solid |
| 5 | Comparison | H24 | 0.89 | 194 | 224 | 7.9 | 89 | Too solid |
| 6 | Invention | H22 | 1.15 | 137 | 178 | 14.8 | 66 | OK |
| 7 | Invention | H22 | 0.7 | 130 | 176 | 16.5 | 67 | OK |
| 8 | Invention | H24 | 0.61 | 162 | 171 | 15 | 77 | OK |
| 9 | Comparison | H14 | 0.81 | 183 | 194 | 3 | 30 | Too solid, |
| | | | | | | | | too little |
| | | | | | | | | elongation |
| 10 | Comparison | O | 0.59 | 40 | 109 | 30 | 85 | Too soft |
| 11 | Invention | H24 | 0.9 | 165 | 181 | 15 | 25 | OK |
| 12 | Invention | H22 | 0.66 | 143 | 168 | 13 | 82 | OK |

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Use of a rolled product made of an aluminium alloy for a battery cell housing having an aluminium alloy with the following alloy components in % by weight:
$$0.1 \% \leq Si \leq 0.7 \% ,$$
$$0.2 \% \leq Fe \leq 0.8 \% ,$$
$$Cu \leq 0.6 \% ,$$
$$0.3 \% \leq Mn \leq 1.5 \% ,$$
$$0.0025 \% \leq Mg \leq 0.6 \% , preferably 0.01 wt \% \leq Mg \leq 0.6 \% ,$$
$$Cr \leq 0.25 \% ,$$
$$Zn \leq 0.5 \% ,$$
$$Ti \leq 0.2 \% ,$$
with the remainder Al and unavoidable impurities, individually a maximum of 0.05%, in total a maximum of 0.15%, wherein the rolled product has a tensile strength Rₘ of at least 135 MPa up to a maximum of 210 MPa, preferably a maximum of 185 MPa, a yield strength R_{p0.2} of more than 125 MPa up to a maximum of 180 MPa, preferably a maximum of 165 MPa, and an elongation A₅₀ of more than 5%, preferably more than 7%.

2. The use according to claim 1,
wherein

3. The use according to claim 1,
wherein
the proportion of recycled metal in the rolled product is at least 30% by weight, preferably at least 50% by weight, particularly preferably at least 70% by weight.

4. The use according to claim 1,
wherein
the rolled product has the temper state H12, H24, H22, H34 or H32.

5. The use according to claim 1,
wherein
the rolled product has a thickness of 0.1 mm to 2.0 mm, preferably 0.25 mm to 1.5 mm and particularly preferably from 0.35 mm to 1.2 mm.

6. The use according to claim 1,
wherein
the rolled product has a degreased surface with surface stresses of more than 30 mN/m, preferably more than 32 mN/m, particularly preferably more than 34 mN/m.

7. Use of a rolled product made of an aluminium alloy for a battery cell housing having an aluminium alloy with the following alloy components in % by weight:
m of at least 135 MPa up to a maximum of 210 MPa, preferably a maximum of 185 MPa, a yield strength R_{p0.2} of more than 125 MPa up to a maximum of 180 MPa, preferably a maximum of 165 MPa, and an elongation A₅₀ of more than 5%, preferably more than 7%, the rolled product preferably manufactured using the method according to claim 12 for the battery cell housing.

8. Use according to claim 1,
wherein

9. Use according to claim 1,
wherein

10. Use according to claim 1,
wherein

11. Use according to claim 1,
wherein

12. Method for manufacturing a rolled product from an aluminium alloy for a use according to claim 1 with the following process steps:
$$Cu \leq 0.6 \% ,$$
$$025 \% < Mg < 0.6 \% , preferably 0.01 \% < Mg < 0.6 \% ,$$

13. Method according to claim 12,
wherein

14. Battery cell housing manufactured from a rolled product in accordance with a use according to claim 1, wherein the battery cell housing has a prismatic design shape, a cylindrical design shape or a pouch design shape.

15. Battery cell housing according to claim 14,
wherein
wall-ironing, a rolled product made of the aluminium alloy in accordance with the use of the rolled product made of the aluminium alloy for the battery cell housing having an aluminium alloy with the following alloy components in % by weight:
m of at least 135 MPa up to a maximum of 210 MPa, preferably a maximum of 185 MPa, a yield strength R_{p0.2} of more than 125 MPa up to a maximum of 180 MPa, preferably a maximum of 165 MPa, and an elongation A₅₀ of more than 5%, preferably more than 7%.
